(19) United States
(12) Patent Application Publication
(10) Pub. No.: US 2015/0082266 A1
(43) Pub. Date: Mar. 19, 2015

(54) METHOD OF DESIGNING INPUT/OUTPUT CIRCUIT

(71) Applicant: Kabushiki Kaisha Toshiba, Minato-ku (JP)

(72) Inventor: Yumiko MIZUTA, Kanagawa-ken (JP)

(73) Assignee: Kabushiki Kaisha Toshiba, Minato-ku (JP)

(21) Appl. No.: 14/200,485

(22) Filed: Mar. 7, 2014

(30) Foreign Application Priority Data
Sep. 13, 2013 (JP) 2013-191100

(51) Int. Cl. G06F 17/50

(52) U.S. Cl. CPC G06F 17/5072
USPC 716/118

(57) ABSTRACT

According to one embodiment, a method of designing an input/output circuit which includes input/output cells of a semiconductor device is provided. The method uses a computer which has a schematic generating unit and a layout generating unit. By the schematic generating unit, a symbol of one input/output cell is arranged on a schematic diagram so as to generate schematic data. The symbol has pins including a through pin, a power pin and information indicating power rails. The symbol is capable of being set so as to connect the through pin of the symbol to a pin of a symbol of another input/output cell or to the power pin of the symbol of the one input/output cell itself selectively. After generating the schematic data, the connection is set. Further, layout data is generated by the layout generating unit.

### CROSS-REFERENCE TO RELATED APPLICATION

This application is based upon and claims the benefit of priority from the prior Japanese Patent Application No. 2013-191100, filed on Sep. 13, 2013, the entire contents of which are incorporated herein by reference.

### FIELD

Embodiments described herein relate generally to a method of designing an input/output circuit.

### BACKGROUND

A semiconductor device, for example, is provided with an input/output circuit (hereinafter, referred to as an “IO circuit”). The input/output circuit is provided with an electro-static discharge (ESD) protection element, and is arranged in the periphery of a circuit portion of a core section. The IO circuit inputs or outputs signals for the circuit portion of the core section. In such a semiconductor device, it is desirable to reduce the layout area of the IO circuit in order to decrease a chip area.

### BRIEF DESCRIPTION OF THE DRAWINGS

FIG. 1 is a diagram illustrating a configuration of a computer in which a method of designing an IO circuit according to an embodiment is implemented;

FIG. 2 is a flowchart illustrating the method of designing the IO circuit according to the embodiment;

FIG. 3 is a flowchart illustrating a process of generating schematic data in the embodiment;

FIG. 4A is a diagram illustrating an example of a symbol of an input/output cell in the embodiment;

FIG. 4B is a circuit diagram illustrating an example of a connection relation in the IO cell;

FIG. 4C is a diagram for explaining a circuit configuration in which the symbol and portions of power rails are included;

FIG. 5 is a flowchart illustrating a process of generating layout data in the embodiment;

FIGS. 6A and 6B are diagrams respectively illustrating objects of the IO cell and the power rails in the embodiment;

FIGS. 7A and 7B are diagrams respectively illustrating the schematic data and the layout data including the power rails in a case where through pins of the IO cell are connected to power pins of the IO cell in the embodiment;

FIG. 7C is a diagram for explaining a circuit configuration in a case where an ESD protection element and connection lines are added to the schematic data of FIG. 7A;

FIGS. 8A and 8B are diagrams respectively illustrating the schematic data and the layout data in a case where the through pins of the IO cell are connected to the pins of another IO cell in the embodiment;

FIGS. 9A and 9B are diagrams respectively illustrating a pattern example and the layout data of the power rails obtained in correspondence with the pattern example by the embodiment;

FIG. 10 is a diagram illustrating a configuration example of a semiconductor device to which the method of designing of the IO circuit according to the embodiment is applied;

FIG. 11 is a diagram illustrating a configuration example of a solid-state imaging device to which the method of designing of the IO circuit is applied;

FIG. 12 is a block diagram illustrating a configuration example of an imaging system including the solid-state imaging device to which the method of designing of the IO circuit is applied; and

FIG. 13 is a diagram illustrating an arrangement example of the imaging system including the solid-state imaging device to which the method of designing of the IO circuit is applied.

### DETAILED DESCRIPTION

According to one embodiment, a method of designing an input/output circuit which includes input/output cells of a semiconductor device is provided. The method uses a computer which has a schematic generating unit and a layout generating unit. By the schematic generating unit, a symbol of one input/output cell is called from a cell library and the symbol is arranged on a schematic diagram so as to generate schematic data. The symbol has pins which are arranged at positions corresponding to an object of the one input/output cell in a corresponding order and have a through pin and a power pin. The symbol has information indicating power rails including information indicating a through line and a power line. The through line is connected to the through pin and passes through the input/output cell without being connected to an element of the input/output cell. The power line is connected to the power pin and the element of the input/output cell. The symbol is capable of being set so as to connect the through pin of the symbol to a pin of a symbol of another input/output cell or to the power pin of the symbol of the one input/output cell itself selectively. The through pin set to connect to the pin of the symbol of the other input/output cell or to the power pin of the symbol of the one input/output cell, after the generating of the schematic data. The object of the one input/output cell and an object of the power rails are arranged on a layout diagram according to the generated schematic data so as to generate layout data, by the layout generating unit.

Hereinafter, further embodiments will be described with reference to the drawings. In the drawings, the same reference numerals denote the same or similar portions respectively.

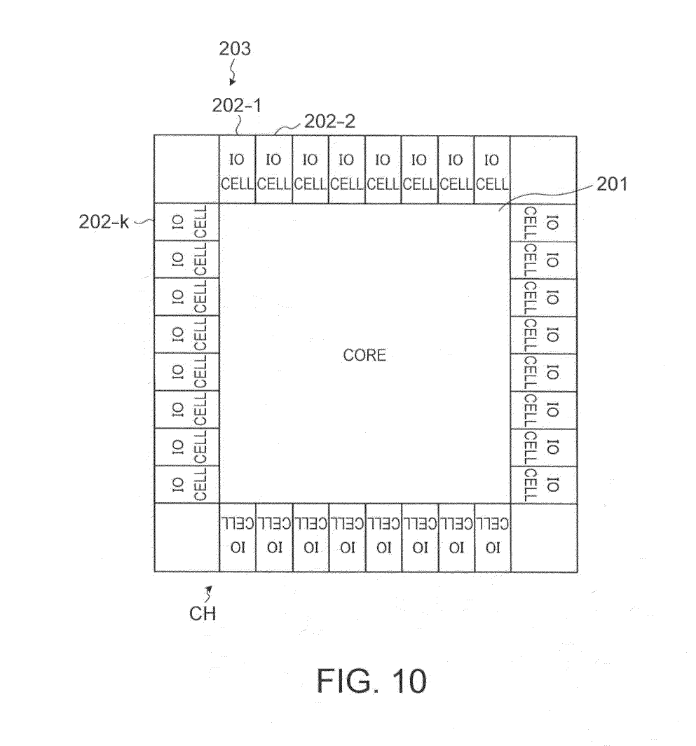

FIG. 10 is a diagram illustrating a configuration example of a semiconductor device to which a method of designing of an IO circuit according to the embodiments is applied. As illustrated in FIG. 10, the semiconductor device is composed of a chip CH, for example. The chip CH is provided with a core section 201 and an IO circuit 203.

The core section 201 is a section in which a circuit portion serving a central function in the semiconductor device is arranged. The core section 201 is disposed on an inner side of the IO circuit 203 in the chip CH. The IO circuit 203 is arranged in the periphery of the core section 201 to surround the core section 201.

The IO circuit 203 is a circuit which inputs or outputs signals for the circuit portion of the core section 201. The core section 201 includes IO cells 202-1 to 202-k. Each of the IO cells 202-1 to 202-k includes an electro-static-discharge (ESD) protection element, for example. The ESD protection element protects the circuit portion of the core section 201 against an electro-static surge etc.

The IO circuit 203 is designed using an electronic design automation (EDA) tool. As described below, the EDA tool includes a schematic editor, a layout editor, a wiring tool, and a verification tool, for example. In designing of the IO circuit 203 illustrated in FIG. 10 using the EDA tool, a schematic diagram (a circuit diagram) is designed using the schematic editor to generate schematic data. For example, symbols of the IO cells 202-1 to 202-k are respectively called from a cell library, and arranged on the schematic diagram.

A layout diagram is designed by the layout editor according to the schematic data to generate layout data. For example, objects of the IO cells 202-1 to 202-k and power rails are arranged on the layout diagram according to the schematic data to generate the layout data. The wirings are drawn between the circuits on the layout diagram by the wiring tool. The design of the layout diagram is verified by the verification tool about whether the design is matched with that of the schematic diagram, or about whether the design meets a physical design rule.

When the IO circuit 203 is designed, the synchronization between the schematic data and the layout data is necessary in order to use an advanced automation function of the EDA tool. In a case where the information indicating the power rails such as GND, VDD, and VSS is not configured as symbols of the IO cell, the EDA tool tends to be unable to determine the layout in the schematic data of the IO cell for the power rails present in the layout data. Even viewing the schematic diagram, it may not be ascertained how many power rails the layout diagram has and what connections are made in the layout diagram at all. Thus, it is difficult to synchronize the schematic data with the layout data and to use such an advanced automation function of the EDA tool.

The symbol types of the IO cell included in the cell library are desirably reduced in number for the efficient management of the design environment in the IO circuit 203. However, the circuit of the core section 201 and the IO circuit 203 require multiple types of power source such as GND, VDD, and VSS. Further, the power rails need to be drawn around, by making the power rails passing above the IO cell, or by connecting the power rails to an element such as an ESD protection element provided in the IO cell. The way of using the power rails becomes different in each IO cell by drawing the power rails as described above. Thus, symbols of derivative cells may be needed for IO cells incorporating elements which have the same function respectively. For example, symbols of the derivative cells may need to be prepared as many as patterns of ways of using the power rails. Accordingly the symbol types of IO cells to be included in the cell library may be increased in number.

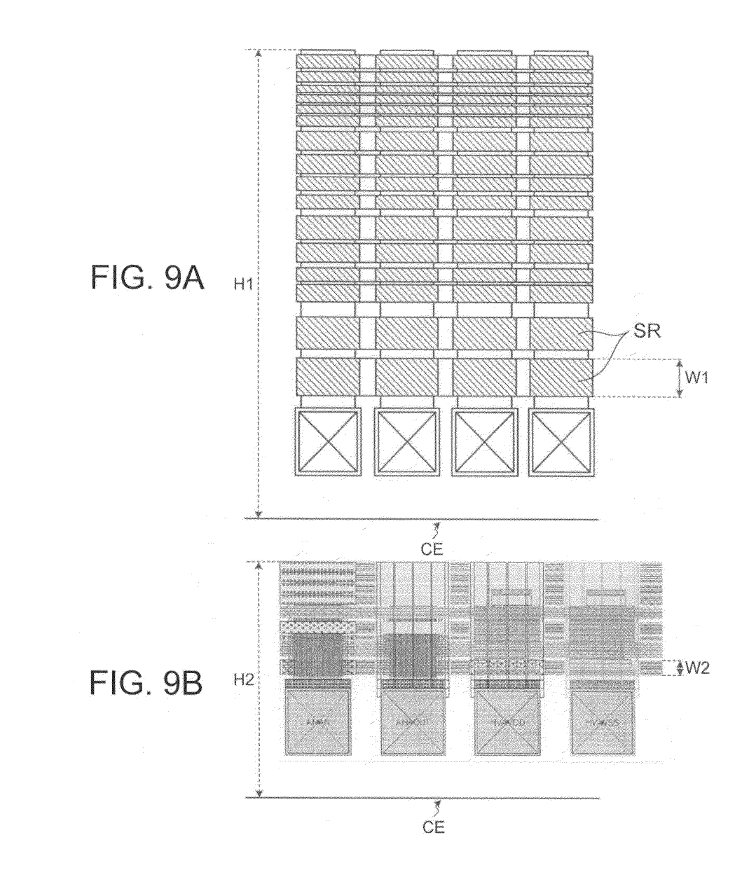

Further, in a case where the semiconductor device is an application specific integrated circuit (ASIC), power rails tend to be prepared as many as patterns of ways of using the power rails. In the case, since the power rails to be prepared increases in number, a height H1 from a chip edge CE of the IO circuit increases as illustrated in FIG. 9A. Thus, the layout area of the IO circuit increases. FIG. 9A is a diagram illustrating a layout of the IO circuit.

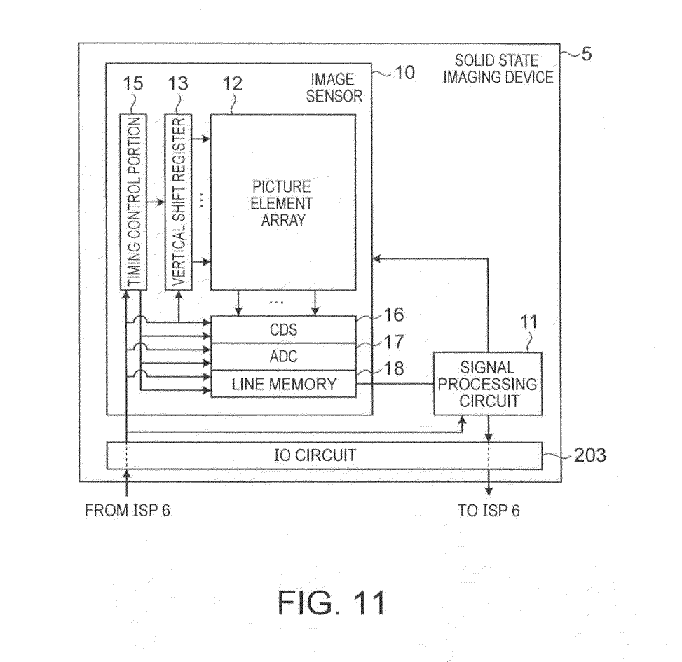

In a case where the semiconductor device is a solid-state imaging device, it is necessary to arrange pixels as many as required in a pixel array 12 as illustrated in FIG. 11. Thus, a predetermined layout area is required as the area of the core section 201 as illustrated in FIG. 10. For this reason, when the IO circuit is applied to the solid-state imaging device as illustrated in FIG. 9A, the chip area tends to increase as the layout area of the JO circuit increases.

In the embodiment, information of pins corresponding to a layout object is assigned to a symbol of an IO cell. Further, an operator makes a computer to have a function of switching connection of the pins according to a way of using power rails. Thus, it is possible to easily synchronize the schematic data and the layout data, to suppress increase of the number of types of symbols that the IO cell requires, and to reduce a chip area.

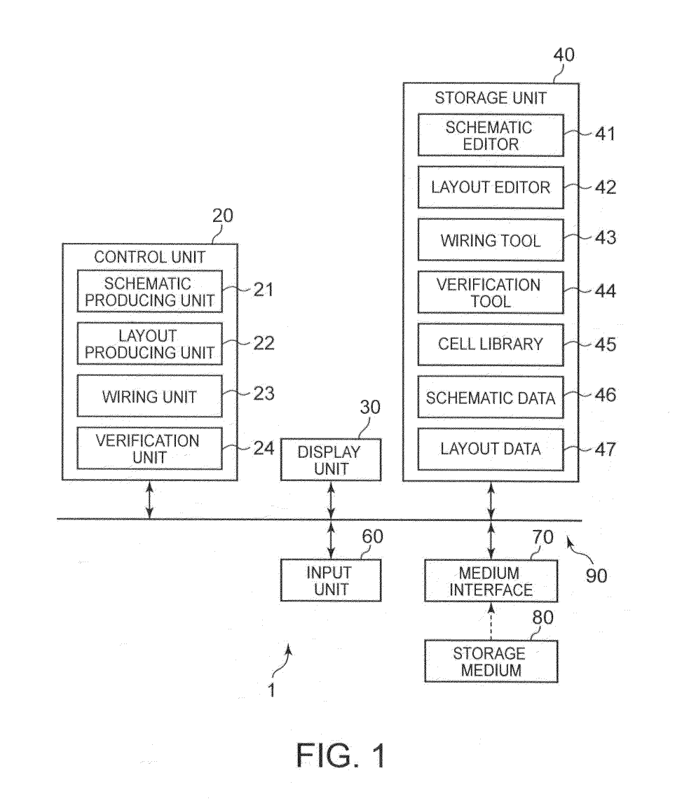

The method of designing of the IO circuit according to the embodiment is implemented on the computer as illustrated in FIG. 1. FIG. 1 is a diagram illustrating a configuration of the computer in which the method of designing of the IO circuit according to the embodiment is implemented.

A computer 1 is provided with a bus line 90, a control unit 20, a display unit 30, a storage unit 40, an input unit 60, and a medium interface 70.

The control unit 20, the display unit 30, the storage unit 40, the input unit 60 and the medium interface 70 are connected to one another through the bus line 90. The medium interface 70 is configured in a connectable manner to a storage medium 80.

The storage unit 40 stores the respective programs of a schematic editor 41, a layout editor 42, a wiring tool 43 and a verification tool 44. Further, the storage unit 40 stores a cell library 45, schematic data 46 and layout data 47.

The schematic editor 41 is an EDA tool for designing a schematic level (a circuit diagram level) in designing an integrated circuit etc. The layout editor 42 is an EDA tool for designing a cell arrangement etc. at a layout level in designing of the integrated circuit etc. The wiring tool 43 is an EDA tool for designing the wirings between circuits at the layout level in designing an integrated circuit etc. The verification tool 44 is an EDA tool for verifying whether the design of the layout diagram is matched with that of the schematic diagram, or whether the design of the layout diagram meets the physical design rule in designing an integrated circuit etc.

The cell library 45 is a database which includes symbols of cells serving as a template when design at a schematic level is performed. The cell library 45 includes the symbols of the IO cells, for example. Each IO cell included in the cell library 45 has pins, through lines, power lines described below. The through lines and the power lines represent types of power rails.

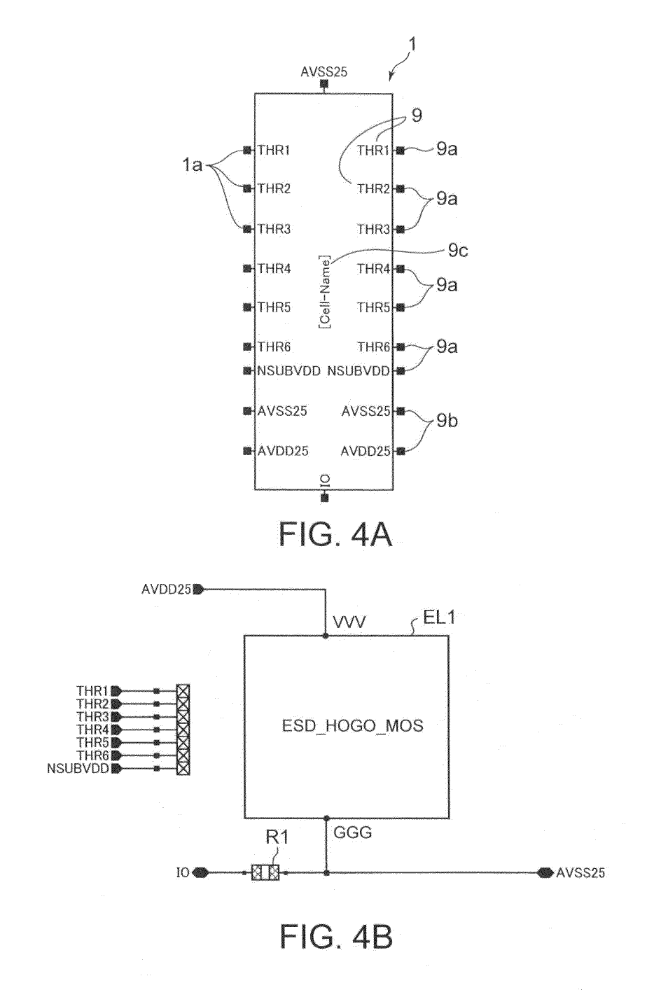

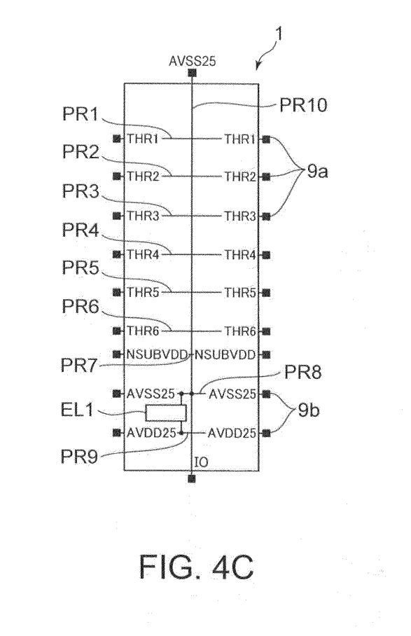

FIG. 4A is a diagram illustrating an example of a symbol of an IO cell which includes an ESD protection element. FIG. 4B is a circuit diagram illustrating an example of a connection relation in the IO cell of FIG. 4A. FIG. 4C is a diagram for explaining a specified circuit configuration in which the symbol of FIG. 4A and the power rails are included.

As illustrated in FIG. 4A, a symbol 1 has pins 1a. The pins 1a are arranged at positions corresponding to an object to be arranged for layout in a corresponding order. The symbol of each IO cell included in the cell library 45 has information for identifying pins, for example, pin names 9. With this configuration, the symbol 1 of the IO cell can be assigned with information of the pins 1a corresponding to an object of the power rails to be arranged for layout. The pins 1a include through pins 9a and power pins 9b. In other words, the symbol of each IO symbol has information indicating power rails including through lines and the power lines.

The pins include the through pins and the power pins. The power pins correspond to the power rails which are commonly used for the IO cells 202-1 to 202-k to be designed as illustrated in FIG. 10. The through pins correspond to the power rails which may or may not be used between the IO cells 202-1 to 202-k to be designed as illustrated in FIG. 10. In the case of the symbol 1 of the IO cell illustrated in FIG. 4A, THR1, THR2, THR3, THR4, THR5, THR6 and NSUBVDD among the pin names 9 represent the through pins 9a. Further, AVSS25 and AVDD25 represent the power pins 9b.

The operator can set the symbol 1 of the IO cells by selecting whether to connect the through pins 9a to a pin of a symbol of another IO cell, or whether to connect the through pins 9a to the power pins 9b of the symbol 1 of the IO cell itself, using the input unit 60. For example, the operator can assign pin connection information to the symbol 1 of the IO cell using the input unit 60. The pin connection information may be a target pin name of an IO cell, a name of an IO cell at a destination to be connected, and a pin name of the IO cell at a destination to be connected. The operator can cause a schematic generating unit 21 of the control unit 20 described below to generate, for example, the power lines by assigning the connection information to the computer 1. Alternatively, according to a well-known technology, the operator designates a target pin and a pin of a IO cell at a destination to be connected on the display unit 30 using a pointing device such as a light pen, so as to assign the pin connection information to the schematic generating unit 21. In this way, power lines etc. can be generated on a displayed schematic diagram. Symbols of the other IO cells are also the same. As described above, it is designated to connect a through pin of an IO cell to a pin of another IO cell in order to assign a pin connection information to a symbol of the IO cell.

Through pins of each IO cell are connected to corresponding through lines. The through lines pass through each IO cell simply without being connected to an element in each IO cell. For example, in the case of the symbol 1 of the IO cell illustrated in FIG. 4A, the through pins THR1 to THR6, NSUBVDD on a right side of the IO cell simply pass through the IO cell and are connected to the through pins THR1 to THR6, NSUBVDD on a left side by through lines (the power rails) PR1 to PR7 without being connected to an ESD protection element EL1 provided in the IO cell as illustrated in FIG. 4C.

Power pins are connected to corresponding power lines respectively. The power lines are connected to an element provided in an IO cell. For example, in the case of the symbol 1 of the IO cell illustrated in FIG. 4A, the power line (the power rail) PR8 for connecting the right and left power pins AVSS25 of the IO cell and the power line (the power rail) PR9 for connecting the right and left power pins AVDD25 are connected to the ESD protection element EL1 provided in the IO cell through vias as illustrated in FIGS. 4B and 4C. The ESD protection element EL1 has the name “ESD_HOGO_MOS”, for example In FIG. 4B, a terminal VVV of the ESD protection element EL1 is connected to the power pin AVDD25. A terminal GGG of the ESD protection element EL1 is connected to the power pin AVSS25 and an end of a dummy resistor R1. The other end of the dummy resistor R1 is connected to an input/output pin JO. The through lines (the power rails) PR1 to PR7, PR10 and the power lines (the power rails) PR8, PR9 in FIG. 4C will be described below.

The control unit 20 illustrated in FIG. 1 may be a unit such as a central processing unit (CPU), a graphics processing unit (GPU), a digital signal processor (DSP) or a microcontroller. The control unit 20 may further include a cache memory for temporary storage. The control unit 20 includes the schematic generating unit 21, a layout generating unit 22, a wiring unit 23, and a verification unit 24.

The schematic generating unit 21 is functionally realized in the control unit 20 by performing the schematic editor 41. For example, the schematic generating unit 21 calls a symbol of an IO cell from the cell library 45, and arranges the symbol on a schematic diagram to generate the schematic data 46.

The layout generating unit 22 is functionally realized in the control unit 20 by performing the layout editor 42. The layout generating unit 22 arranges objects of IO cells and power rails on a layout diagram according to the schematic data 46 generated by the schematic generating unit 21 to generate the layout data 47.

The wiring unit 23 is functionally realized in the control unit 20 by performing the wiring tool 43. The wiring unit 23 draws wirings between circuits displayed on the layout diagram.

The verification unit 24 is functionally realized in the control unit 20 by performing the verification tool 44. The verification unit 24 verifies whether the design of the layout diagram is matched with that of the schematic diagram, or whether the design meets the physical design rule.

The display unit 30 illustrated in FIG. 1 may be a display such as a CRT display or a liquid crystal display. The storage unit 40 may be a memory or a hard disk. The input unit 60 may be a keyboard or a mouse. The medium interface 70 may be a flexible disk drive, a CD-ROM drive or a USB interface. The storage medium 80 may be a flexible disk, a CD-ROM or a USB memory.

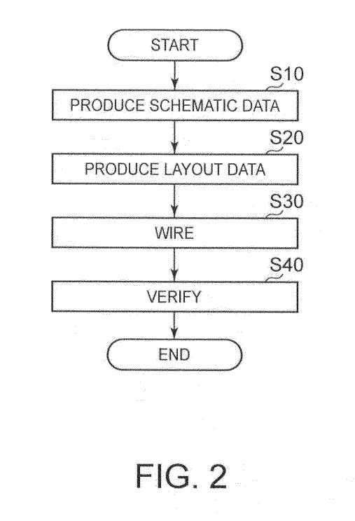

The method of designing an IO circuit according to the embodiment will be described using a flowchart of FIG. 2.

In Step S10, the schematic generating unit 21 performs a process of generating the schematic data 46. A detailed process of generating the schematic data 46 will be described below.

In Step S20, the layout generating unit 22 performs a process of generating the layout data 47. A detailed process will be described below.

In Step S30, the wiring unit 23 draws wirings between circuits. Specifically, the control unit 20 activates the wiring tool 43 in response to an activation command received from a user through the input unit 60 to realize the wiring unit 23 in the control unit 20. The wiring unit 23 draws the wirings between the circuits on the layout diagram (the layout data 47) generated in Step S20 in response to a process command received from the user through the input unit 60.

In Step S40, the verification unit 24 performs a predetermined verification. Specifically, the control unit 20 activates the verification tool 44 in response to the activation command received from the user through the input unit 60 to realize the verification unit 24 in the control unit 20. The verification unit 24 performs a predetermined verification in response to the process command received from the user through the input unit 60. For example, the verification unit 24 reads out the schematic data 46 and the layout data 47 from the storage unit 40 for comparison between the schematic data 46 and the layout data 47. By the comparison, the verification unit 24 verifies whether the design of the layout diagram is matched with that of the schematic diagram. Further, the verification unit 24 reads out the layout data 47 from the storage unit 40 for comparison between the layout data 47 and reference data (design rule data). By the comparison, the verification unit 24 verifies whether the design of the layout diagram meets the physical design rule. When it is determined that any problem does not arise as a result of the verification, a mask is created according to the layout data 47. Exposure and development performed for a semiconductor substrate using the created mask so as to produce a semiconductor device.

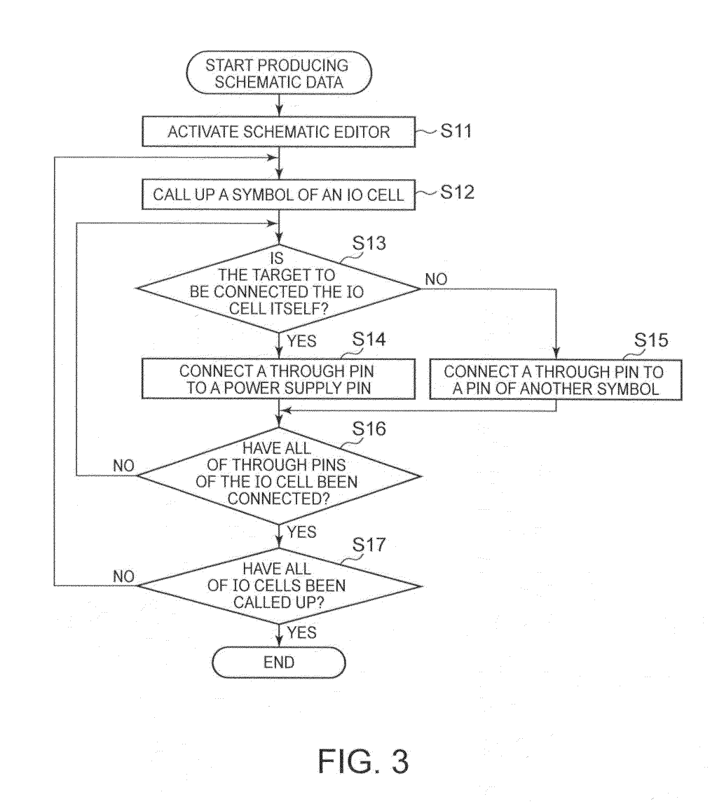

A detailed process of generating the schematic data 46 in Step S10 will be described using FIG. 3 and FIGS. 4A to 4C. FIG. 3 is a flowchart illustrating the process of generating the schematic data 46 according to the embodiment.

In Step S11 of FIG. 3, the control unit 20 of FIG. 1 activates the schematic editor 41 in response to the activation command received from the user through the input unit 60 in order to realize the schematic generating unit 21 in the control unit 20. The schematic generating unit 21 displays the schematic diagram which is a virtual plane realized in the control unit 20, on the display unit 30.

In Step S12, the schematic generating unit 21 calls a symbol of an IO cell from the cell library 45. Specifically, the schematic generating unit 21 accesses the cell library 45 of the storage unit 40 in response to a command received from the user through the input unit 60. Further, the schematic generating unit 21 displays information of IO cells which are candidates to be called, for example, names of the IO cells such as a name 9c in FIG. 4A, on the display unit 30. The schematic generating unit 21 receives a designation command for designating an IO cell from the user through the input unit 60. In response to the designation command, the schematic generating unit 21 extracts a symbol of the designated IO cell from the cell library 45. Then, the schematic generating unit 21 adds the extracted symbol at a position designated by the designation command in order to displaying the symbol on the schematic diagram.

For example, the schematic generating unit 21 adds a symbol 1 of an IO cell as illustrated in FIG. 4A on the schematic diagram. As described above, THR1, THR2, THR3, THR4, THR5, THR6 and NSUBVDD represent through pins, and AVSS25 and AVDD25 represent power pins in the case of the symbol 1 of the IO cell illustrated in FIG. 4A.

The schematic generating unit 21 can switch display from the symbol 1 of the IO cell illustrated in FIG. 4A to a circuit diagram of the IO cell illustrated in FIG. 4B in response to a schematic view display command received from the user through the input unit 60. The schematic generating unit 21 can switch a display from the circuit diagram of the IO cell illustrated in FIG. 4B to the symbol of the IO cell illustrated in FIG. 4A in response to a symbol view display command received from the user through the input unit 60. A correspondence relation between the symbol of the IO cell and the internal configuration can be confirmed through such a display switching function. In the circuit diagram of the IO cell illustrated in FIG. 4B, the through pins THR1 to THR6, NSUBVDD are not connected to the ESD protection element EL1 in the IO cell. Thus, it is possible to see that the through pins THR1 to THR6, NSUBVDD on one side of the symbol of the IO cell illustrated in FIG. 4A pass through the IO cell skipping over the ESD protection element EL1 to be connected to the through pins THR1 to THR6, NSUBVDD on the other side of the symbol.

In Step S13, the schematic generating unit 21 determines whether the operator selects through the input unit 60 to connect the through pins of the IO cell added in Step S12 to the power pins of the symbol of the IO cell itself. Specifically, the schematic generating unit 21 selects a target through pin among the through pins of the IO cell added in Step S12. As to the target through pin, connection of the target through pin to another pin will be determined later.

The schematic generating unit 21 can select unselected one among the through pins as the target through pins. In a case of receiving a command for connecting the target through pin to one of the power pins of the symbol of the IO cell itself, the schematic generating unit 21 determines that the operator has made such a connecting selection (“Yes” in Step S13) and the process proceeds to Step S14. On the other hand, in a case of not receiving a command for connecting the target through pin to any one of the power pins of the symbol of the IO cell itself in a predetermined time period, the schematic generating unit 21 determines that the operator has not made such a connecting selection (“No” in Step S13), and the process proceeds to Step S15.

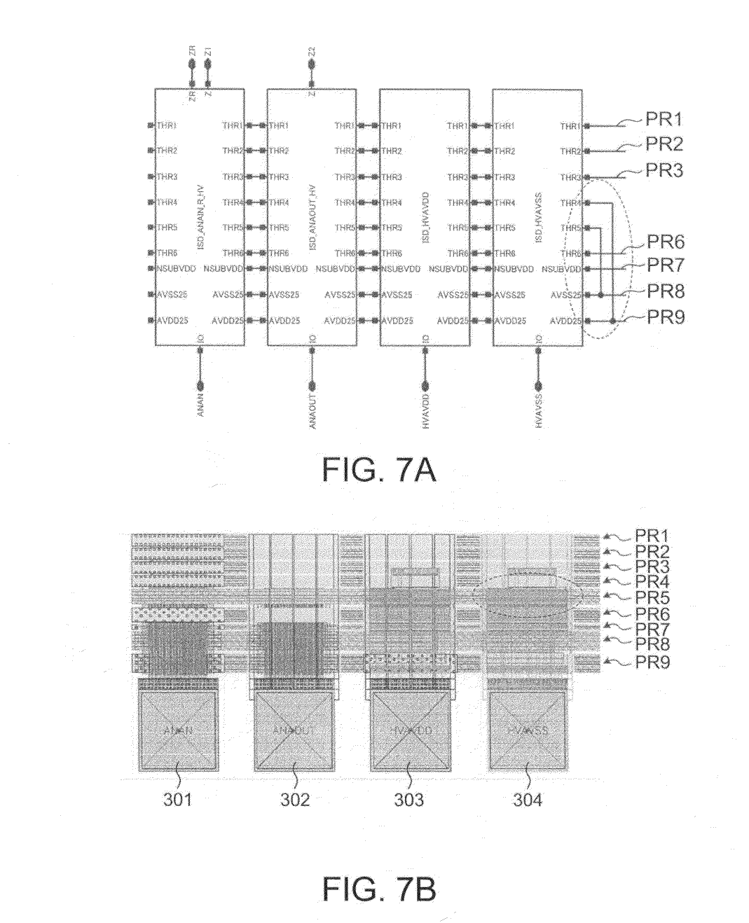

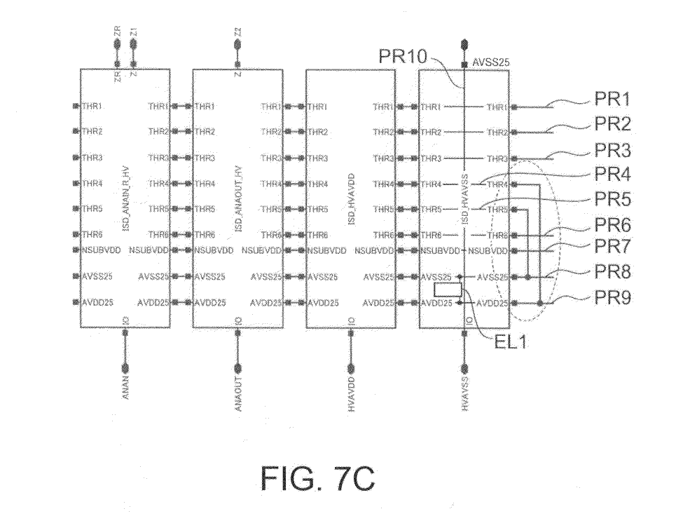

In Step S14, the schematic generating unit 21 performs processing of connecting the target through pin to one of the power pins of the symbol of the IO cell itself. The processing will be described with reference to examples of FIGS. 7A to 7C. FIGS. 7A and 7B are diagrams respectively illustrating the schematic data and the layout data in a case where the through pins of the IO cell are connected to the power pins of the IO cell itself in the embodiment. FIG. 7C is a diagram for explaining a circuit configuration in a case where an ESD protection element and connection lines are added to the schematic data of FIG. 7A.

In a case of a symbol of an IO cell “ISD_HVAVSS” illustrated in FIG. 7A, the schematic generating unit 21 connects a through pin THR4 to a power pin AVDD25 when a target through pin is the through pin THR4. In this case, for the purpose of producing pin connection information of the symbol of the IO cell “ISD_HVAVSS”, the schematic generating unit 21 writes an identifier “ISD_HVAVSS” of the IO cell “ISD_HVAVSS” as an identifier of the IO cell corresponding to the through pin THR4 into the storage unit 40 as the schematic data. In addition, the schematic generating unit 21 writes an identifier “AVDD25” of the power pin AVDD25 as an identifier of a pin at a connecting destination into the storage unit 40 as the schematic data. Alternatively, when the target through pin is a through pin THR5, the through pin THR5 is connected to the power pin AVSS25. In this case, the schematic generating unit 21 assigns the identifier of the IO cell “ISD_HVAVSS” as an identifier of an IO cell at a connection destination corresponding to the through pin THR5. In addition, the schematic generating unit 21 assigns the identifier of the power pin AVSS25 as an identifier of a pin at the connection destination.

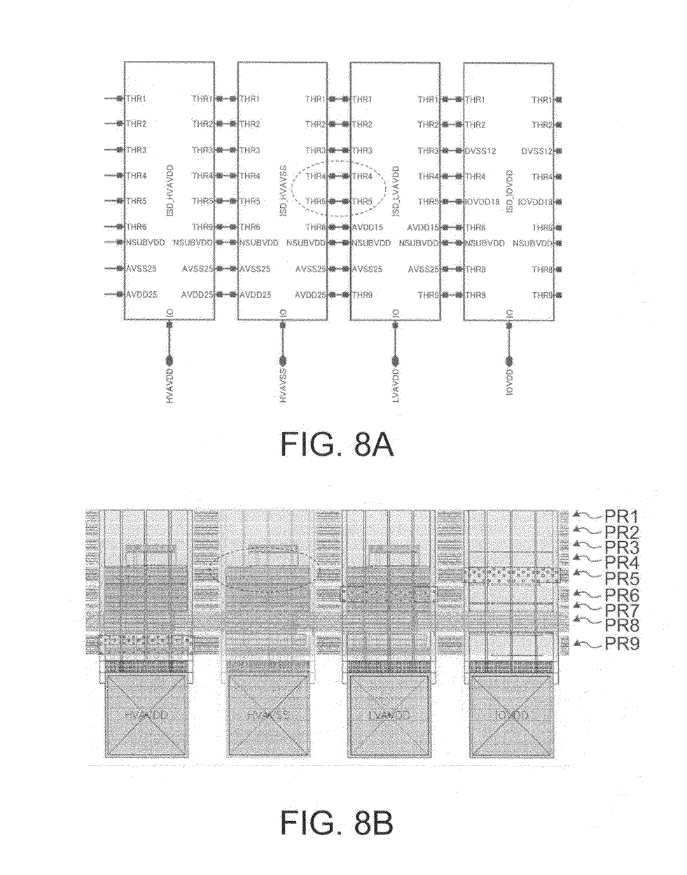

In Step S15, the schematic generating unit 21 performs processing of connecting the target through pin of the IO cell to one of the through pins of a symbol of another IO cell. For example, in a case of a symbol of an IO cell “ISD_HVAVSS” illustrated in FIG. 8A, a through pin THR4 is connected to a through pin THR4 of another IO cell “ISD_LVAVDD” when the target through pin is the through pin THR4. In this case, for the purpose of producing pin connection information of the symbol of the IO cell “ISD_LVAVDD”, the schematic generating unit 21 assigns an identifier of the IO cell “ISD_LVAVDD” as an identifier of an IO cell at a connecting destination corresponding to the through pin THR4. In addition, the schematic generating unit 21 assigns the identifier of the through pin THR4 as an identifier of a pin at the connecting destination. Alternatively, when the target through pin is a through pin THR5 of an IO cell, the through pin THR5 is connected to a through pin THR5 of another IO cell “ISD_LVAVDD”. In this case, for the purpose of producing pin connection information of the symbol of the IO cell “ISD_HVAVSS”, the schematic generating unit 21 assigns the identifier of the IO cell “ISD_LVAVDD” as an identifier of the other IO cell at a connecting destination corresponding to the through pin THR5. In addition, the schematic generating unit 21 assigns the identifier of the through pin THR5 as an identifier of a pin at the connecting destination.

In Step S16, the schematic generating unit 21 determines whether the processes of Steps S13 to S15 have been performed for any of the through pins of the IO cell called in Step S12. In a case where the processes have been performed for all of the through pins (“Yes” in Step S16), the schematic generating unit 21 causes the process to proceed to Step S17. In a case where the processes have not been performed for any of the through pins (“No” in Step S16), the process returns to Step S13.

In Step S17, the schematic generating unit 21 determines whether any of the IO cells 202-1 to 202-k to be arranged for making the IO circuit 203 in FIG. 10 has been called. In a case where all of the IO cells are called (“Yes” in Step S17), the schematic generating unit 21 stores the schematic data 46 in the storage unit 40 and ends the process. In a case where at least one of the IO cells is left uncalled (“No” in Step S17), the process returns to Step S12.

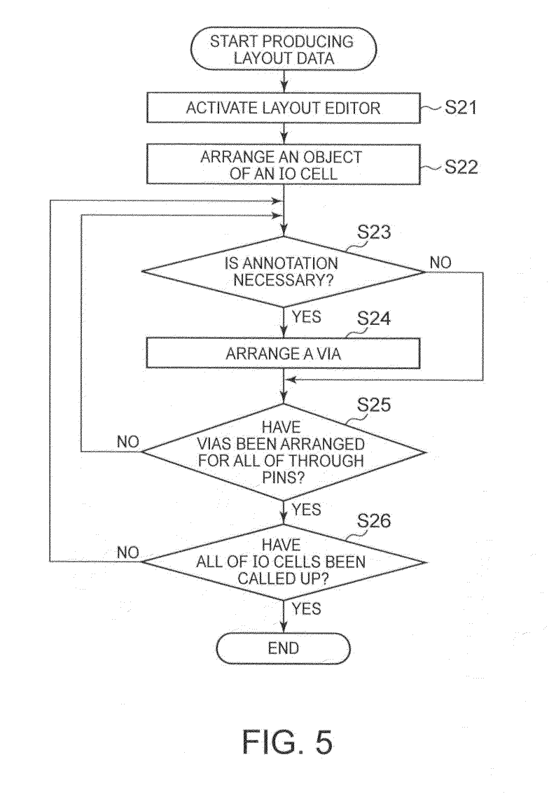

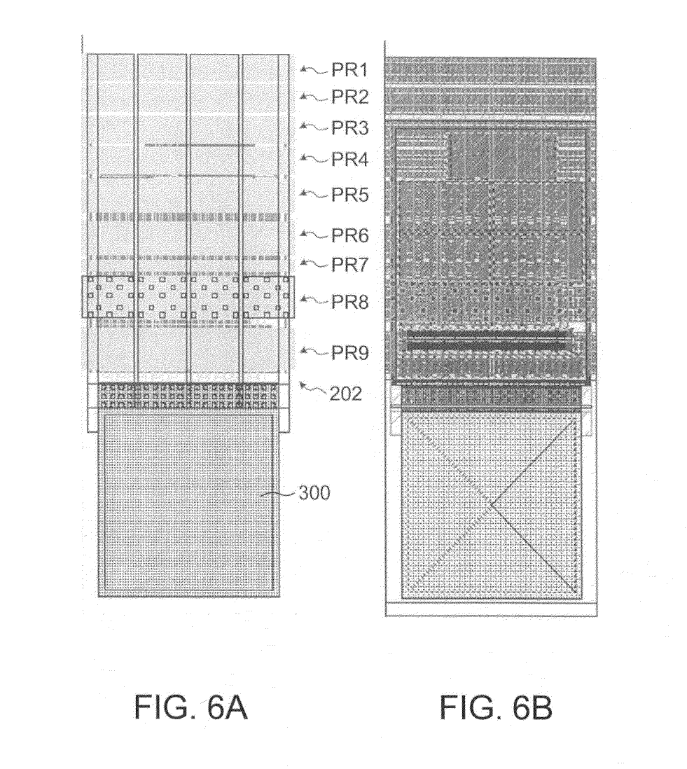

A detailed process of generating the layout data 47 in Step S20 of FIG. 2 will be described using FIG. 5 and FIGS. 6A and 6B. FIG. 5 is a flowchart illustrating a process of generating the layout data 47 in the embodiment. FIGS. 6A and 6B are diagrams illustrating the objects of the IO cell and the power rails in the embodiment.

In Step S21, the control unit 20 illustrated in FIG. 1 activates the layout editor 42 in response to the activation command received from the user through the input unit 60 in order to realize the layout generating unit 22 of the control unit 20. The layout generating unit 22 displays a layout diagram which is a virtual plane realized in the control unit 20, on the display unit 30.

In Step S22, the layout generating unit 22 arranges the objects of the IO cell and the power rails on the layout diagram according to the schematic data 46. Specifically, the layout generating unit 22 accesses the schematic data 46 of the storage unit 40 in response to a command received from the user through the input unit 60 to obtain the schematic data 46. The layout generating unit 22 generates the objects of the IO cell and the power rails according to the schematic data 46, and calculates positions of the objects to be arranged on the layout diagram. The layout generating unit 22 arranges the objects of the IO cell and the power rails on the layout diagram according to the calculation results.

For example, the layout generating unit 22 of FIG. 1 adds the objects of the IO cell and the power rails as illustrated in FIG. 6A on the layout diagram. In the case illustrated in FIG. 6A, the object of the power rails PR1 to PR9 connected to a pad 300 are overlappingly displayed on the object of the IO cell 202. As can be seen by comparing FIGS. 4A and 6A, the through pins THR1, THR2, THR3, THR4, THR5, THR6 and NSUBVDD in the symbol 1 of the IO cell correspond to the power rails PR1, PR2, PR3, PR4, PR5, PR6 and PR7 respectively in the layout diagram. The power pins AVSS25, AVDD25 in the symbol 1 of the IO cell correspond to the power rails PR8, PR9 in the layout diagram respectively.

The layout generating unit 22 switches display from the objects of the IO cell and the power rails as illustrated in FIG. 6A to the detailed objects of the IO cell and the power rails as illustrated in FIG. 6B, in response to a layout view display command received from the user through the input unit 60. Further, the layout generating unit 22 switches display from the detailed objects of the IO cell and the power rails as illustrated in FIG. 6B to the objects of the IO cell and the power rails as illustrated in FIG. 6A, in response to an abstract view display command received from the user through the input unit 60. By such display switching, a correspondence relation between each power rail and lines included in the power rail can be confirmed.

In Step S23, the layout generating unit 22 determines whether to make an annotation which describes the reason for arranging a via according to the schematic data 46.

Specifically, the layout generating unit 22 selects a target IO cell among the IO cells arranged in Step S22. Further, the layout generating unit 22 selects a target through pin among the through pins in the selected IO cell. Furthermore, the layout generating unit 22 determines whether the target through pin is subjected to the process of Step S14 i.e. the process of connecting the through pin to the power pin of the symbol of the IO cell itself. The layout generating unit 22 determines whether the target through pin is subjected to the process of Step S14 of FIG. 3 with reference to the pin connection information of the target IO cell included in the schematic data 46.

In a case where the target through pin is subjected to the process of Step S14, the layout generating unit 22 determines to make an annotation (“Yes” in Step S23). Then, the layout generating unit 22 displays a prompt for arranging a via in a portion corresponding to the through pin in the object of the power rails. For example, the layout generating unit 22 highlights a portion corresponding to the through pin in the object of the power rails, or makes the portion blinking to prompt the user to arrange a via. Then, the layout generating unit 22 causes the process to proceed to Step S24.

In a case where the target through pin is not subjected to the process of Step S14, the layout generating unit 22 determines not to make an annotation (“No” in Step S23). Then, the layout generating unit 22 causes the process to proceed to Step S25.

In Step S24, the layout generating unit 22 connects the portion corresponding to the through pin in the object of the power rails to a line corresponding to the power pin of the IO cell, in response to a command received from the user through the input unit 60. In other words, a via is arranged for connecting the portion corresponding to the through pin and the line. For example, FIG. 7B illustrates the arrangement of the power rails PR and 1 to PR9 connected to pads 301 to 304. In the case illustrated in FIG. 7B, a via is arranged to connect a portion of the power rail PR4 of FIG. 7A corresponding to the through pin THR4 of the IO cell “ISD_HVAVSS”, which is a portion surrounded with a dotted line, to a line of the power rail PR9 corresponding to the power pin AVDD25 of the IO cell “ISD_HVAVSS”. Alternatively, a via is arranged to connect a portion of the power rail PR5 corresponding to the through pin THR5 of the IO cell “ISD_HVAVSS”, which is a portion surrounded with a dotted line, to a power line of the power rail PR8 corresponding to the power pin AVSS25 in the IO cell “ISD_HVAVSS”.

In a case where it is determined not to make an annotation in Step S23, any via is not particularly arranged in the portion corresponding to the through pin in the object of the power rails for the connection of the element in the IO cell. In the case illustrated in FIG. 8B, any via is not particularly arranged in the portion of the power rail PR4 corresponding to the through pin THR4 of the IO cell “ISD_HVAVSS”, which is a portion surrounded with a dotted line, for the connection of the element in the IO cell “ISD_HVAVSS”. Alternatively, any via is not particularly arranged in the portion of the power rail PR5 corresponding to the through pin THR5 of the IO cell “ISD_HVAVSS”, which is the portion surrounded with the dotted line, for connecting the element in the IO cell “ISD_HVAVSS”.

In Step S25, the layout generating unit 22 determines whether all of the through pins in the IO cell have been called in Step S12 are subjected to the processing of Steps S23 and S24. In a case where all of the through pins have been subjected to the processes (“Yes” in Step S25), the layout generating unit 22 causes the process to proceed to Step S26. In a case where at least one of the through pins have not been subjected to the processes (“No” in Step S25), the process returns to Step S23.

In Step S26, the layout generating unit 22 determines whether all of the IO cells 202-1 to 202-k to be arranged to make the TO circuit 203 of FIG. 10 are called. In a case where all of the IO cells are called (“Yes” in Step S26), the layout generating unit 22 stores the layout data 47 in the storage unit 40 and ends the process. In a case where at least one of the IO cells is left unprocessed (“No” in Step S26), the process returns to Step S23.

A solid-state imaging device and an imaging system, to which the method of designing of the IO circuit according to the embodiment is applied, will be described using FIGS. 11 to 13.

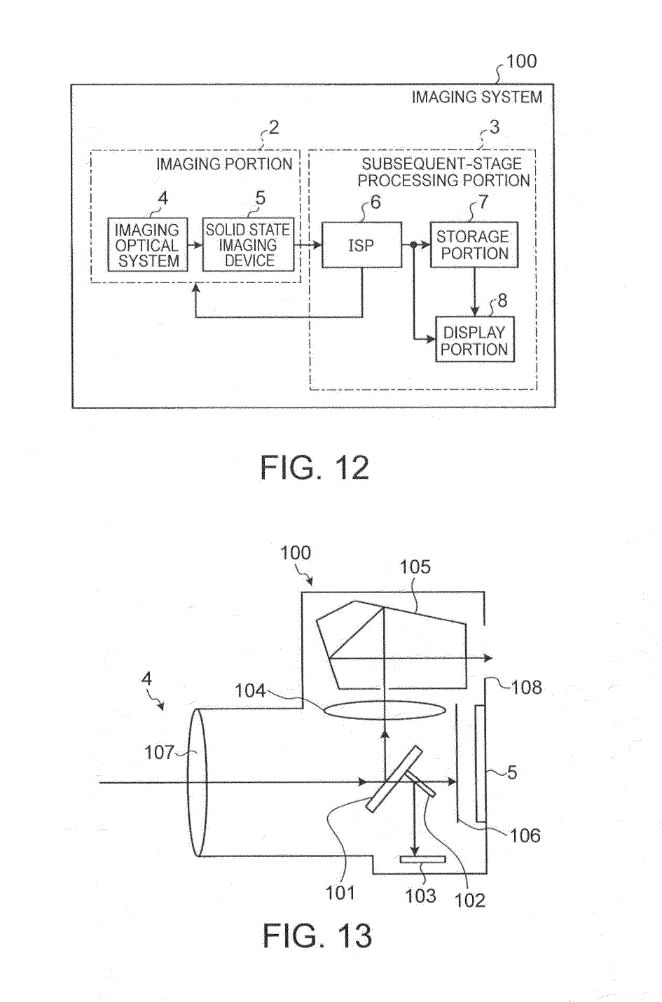

FIG. 11 is a diagram illustrating a configuration example of the solid-state imaging device. FIGS. 12 and 13 are diagrams respectively illustrating a configuration example and an arrangement example of the imaging system which includes the solid-state imaging device.

As illustrated in FIG. 11, a solid-state imaging device 5 includes an image sensor 10, a signal processing circuit 11, and for example the IO circuit 203.

The image sensor 10 may be a CMOS image sensor or a CCD image sensor.

FIG. 11 illustrates an exemplary configuration of a case where the image sensor 10 is the CMOS image sensor. The image sensor 10 includes the pixel array 12, a vertical shift register 13, a timing control unit 15, a correlated double sampling unit (CDS) 16, an analog-digital conversion unit (ADC) 17, and a line memory 18.

The pixel array 12 is configured to include pixels which are disposed two-dimensionally. Each pixel includes a photoelectric conversion unit such as a photodiode. The pixel array 12 generates an image signal according to an amount of light incident on each pixel. A control signal received from an image signal processor (ISP) 6 of the imaging system described below and illustrated in FIG. 12 is provided to the timing control unit 15, the vertical shift register 13, the CDS 16, the ADC 17, the line memory 18, and the signal processing circuit 11. An image signal (or charges) generated in the pixel array 12 is read out to the CDS 16 by operation of the timing control unit 15 and the vertical shift register 13. The read-out image signal is converted into image data while passing through the CDS 16 and the ADC 17. Then, the image data is output to the signal processing circuit 11 through the line memory 18. The signal processing circuit 11 performs a signal processing operation. The image data subjected to the signal processing operation is output to the ISP 6 through the IO circuit 203.

An imaging system 100 illustrated in FIGS. 12 and 13 may be a digital camera or a digital video camera, or may be an electronic device to which a camera module is attached, such as a camera-equipped portable terminal. As illustrated in FIG. 12, the imaging system 100 is provided with an imaging unit 2 and a post-stage processing unit 3. The imaging unit 2 is provided with an imaging optical system 4 and the solid-state imaging device 5. The post-stage processing unit 3 includes the ISP 6, a storage unit 7, and a display unit 8.

As illustrated in FIG. 13, the imaging optical system 4 is provided with an imaging lens 107, half mirrors 101, 102, an automatic focus (AF) sensor 103, a mechanical shutter 106, a lens 104, a prism 105, and a finder 108. The imaging lens 107 may include imaging lenses and a lens driving mechanism (not illustrated). A diaphragm (not illustrated) is arranged between the imaging lenses to adjust the amount of light introduced from the imaging lens arranged on an upstream side of an optical path to the imaging lens arranged on a downstream side of the optical path.

The solid-state imaging device 5 is arranged at an expected imaging plane of the imaging lens 107. The imaging lens 107 refracts an incident light beam to introduce the incident light beam to an imaging surface of the solid-state imaging device 5 through the half mirror 101, the half mirror 102 and the mechanical shutter 106. By introducing the incident light beam, an image of an object is formed on the imaging surface i.e. the pixel array 12 of the solid-state imaging device 5 shown in FIG. 11. The solid-state imaging device 5 generates an image signal according to the formed image of the object.

A light beam which passes through the half mirror 101 and is reflected on the half mirror 102 advances toward the AF sensor 103. The lens driving mechanism described above drives at least one of the imaging lenses provided in the imaging lens 107 along the light axis based on the control of the ISP 6 illustrated in FIG. 12. The ISP 6 calculates focus control information depending on a detection result of the AF sensor 103 of FIG. 13 in accordance with an auto-focus function. Then, the ISP 6 controls the lens driving mechanism based on the focus control information. By the control, the imaging lens 107 is adjusted so as to be in a focusing state i.e. just focus.

In the embodiment described above, the IO cell to be called when the schematic data is generated in designing the IO circuit includes the pins, the through lines, and the power lines. The pins are arranged at the positions corresponding to the layout objects in a corresponding order. The pins include the through pins and the power pins. Each through line is connected to each through pin. The through lines pass through the IO cell skipping over the element in the IO cell, for example, the ESD protection element. Each power line is connected to each power pin so as to be connected to the element in the IO cell. With such a configuration, the symbol arranged on the schematic diagram can be assigned with the information of the pins which correspond to the object of the layout power rails. Thus, a person can ascertain which power rails are included in the layout diagram and which wirings are connected, by seeing the schematic diagram. As a result, the schematic data and the layout data are easily synchronized. Further, the advanced automation function of the EDA tool can be easily used.

In the embodiment, in order to generate schematic data in designing an IO circuit, the computer has a function that the operator can select and set about, for a symbol of a called IO cell, whether a target through pin is connected to a pin of a symbol of another IO cell, or the target through pin is connected to a power pin of the symbol of the called IO cell itself. By using such a function for connecting to the symbols selectively, even in a case where a plurality of patterns of way of using a power rail for IO cells which include elements having the same function respectively, the IO cells can be designed using a symbol of an IO cell in common. As a result, it is not always necessary to prepare symbols of derivative cells.

In a case where DVSS cells are designed as the IO cells having the same function, the DVSS cells are generally prepared as many as the patterns corresponding to the ways of using a power rail. Five types of layout blocks are prepared for the same circuit, for example. These layout blocks have differences produced only by changing wiring of a power rail with arrangement of a pad. Specifically, the ways of using the power rail include using the power rail for strengthening power supply to a protection element in each DVSS cell, simply passing through the IO cell without being connected to the element in each DVSS cell when the power rail is a ground (GND) rail, or using wiring layers overlapping with each other at the same coordinates for different uses.

In the IO cell of the embodiment, even if the ways of using the power rail are different, the design can be made using one symbol. Even if five layouts are present according to the patterns corresponding to the ways of using the power rail, the schematic data i.e. net information can be assigned to the layouts by changing a wiring of one symbol provided in one upper layer from a circuit diagram.

Thus, it is possible to make the symbol of the derivative cells unnecessary for the patterns corresponding to the ways of using the power rail. As a result, the types of symbols of IO cells included in the cell library can be reduced in number. Further, the design environment of an JO circuit can be efficiently managed.

FIGS. 9A and 9B are diagrams illustrating a pattern example and a layout data of the power rails obtained by the embodiment in correspondence with the pattern example. Generally, in a case where the semiconductor device is an ASIC, the power rails tend to be prepared as many as the patterns corresponding to the ways of using the power rail. In the case, as illustrated in FIG. 9A, the power rails to be prepared increases in number. The width of the power rail SR needs to be large to a width W1, for example, according to a power level so that a voltage which is applied to an ESD protection element in the IO circuit of the semiconductor device may become lower than a breakdown voltage. According to such a design, a height H1 from a chip edge CE of the IO circuit or the semiconductor device increases, which may cause increase of the layout area of the IO circuit.

On the contrary, in the embodiment, in order to generating schematic data in designing an IO circuit, a computer has a function that an operator can select and set, for a symbol of one called IO cell, whether a through pin of the IO cell is connected to a pin of a symbol of another IO cell, or to a power pin of the symbol of the IO cell itself. By such a function, for patterns corresponding to ways of using a power rail, design of IO cells can be performed using the symbol of one IO cell in common. As illustrated in the objects of FIG. 9B, power rails to be prepared can be reduced in number. Further, power rails can be effectively used with respect to one power source by connecting the through pin of the IO cell to the power pin of the symbol of the IO cell itself according to a power level. Thus, as illustrated in FIG. 9B, the width of each power rail is narrow compared to that illustrated in FIG. 9A. For example, the width can be set to satisfy W2<W1. Further, an effective wiring width of the one power source can be larger. By such a design, a height H2 from the chip edge CE of the IO circuit can be significantly reduced compared to that illustrated in FIG. 9A. Further, the layout area of the IO circuit can be easily reduced.

In the embodiment, a semiconductor device which includes an JO circuit designed as described above is a solid-state imaging device. In the solid-state imaging device, it is necessary to arrange pixels as many as required in a pixel array. Thus, a predetermined layout area is required as the area for a core section of an IO circuit. Even in this case, the layout area of the IO circuit can be easily reduced as described above. Accordingly, the chip area of the solid-state imaging device can be reduced while satisfying the required number of pixels of the solid-state imaging device.

In the above-mentioned embodiment, in order to generate schematic data in designing an IO circuit, by command from an operator, the schematic generating unit 21 makes a selection for a symbol of the IO cell, i.e. a selection about whether a through pin of one IO cell are connected to a pin of a symbol of another IO cell or to a power pin of the symbol of the IO cell itself. In a case where the through pin of the IO cell is connected to the power pin of the symbol of the IO cell itself in generating the schematic data, the layout generating unit 22 of FIG. 1 displays a prompt for arranging a via in a portion corresponding to the through pin in the object of the power rails in generating the layout data. On the basis of the determination on whether the IO cell in a net-driven layout needs to make a wiring based on the schematic data (net information) of the IO circuit obtained as net information, a via may be generated if necessary. For example, in a case where the via is not necessary as in a case where a through wiring is used, it is possible to set the via not to be generated. Accordingly, the flexibility in the power rail design can be easily enhanced, and the net-driven layout can be obtained. Further, the layout can be completed while wiring mistakes are reduced simply.

As described above, a time necessary for designing an IO cell can be reduced using a cell library of the embodiment. Circuits and layouts can be easily changed and edited. Furthermore, a complicated drawing of multi-layered wirings can be verified in real time which contributes to developing products efficiently.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of designing an input/output circuit including input/output cells of a semiconductor device using a computer which has a schematic generating unit and a layout generating unit, comprising:
calling a symbol of one input/output cell from a cell library and arranging the symbol on a schematic diagram so as to generate schematic data by the schematic generating unit, the symbol has pins which are arranged at positions corresponding to an object of the one input/output cell in a corresponding order and have a through pin and a power pin, the symbol has information indicating power rails including information indicating a through line and a power line, the through line being connected to the through pin and passes through the input/output cell without being connected to an element of the input/output cell, the power line being connected to the power pin and the element of the input/output cell, the symbol being capable of being set so as to connect the through pin of the symbol to a pin of a symbol of another input/output cell or to the power pin of the symbol of the one input/output cell itself selectively;
setting the through pin to connect to the pin of the symbol of the other input/output cell or to the power pin of the symbol of the one input/output cell, after the generating of the schematic data; and
arranging the object of the one input/output cell and an object of the power rails on a layout diagram according to the generated schematic data so as to generate layout data, by the layout generating unit.

2. The method according to claim 1, wherein
the pins include through pins which include the through pin, and power pins which include the power pin,
the symbol of the one input/output cell has through lines which include the through line, and power lines which include the power line, and
each of the through pins is set about whether the through pin is connected to the pin of the symbol of the other input/output cell, or is connected to the power pin of the symbol of the one input/output cell itself.

3. The method according to claim 1, wherein, in generating the schematic data, the schematic generating unit selects, on the symbol of the one input/output cell, about whether the through pin is connected to the pin of the symbol of the other input/output cell, or is connected to the power pin of the symbol of the one input/output cell itself.

4. The method according to claim 1, wherein, in generating the layout data, when the through pin is connected to the power pin of the symbol of the one input/output cell itself in generating the schematic data, the layout generating unit displays a prompt for arranging a via in a portion corresponding to the through pin in the object of the power rails.

5. The method according to claim 2, wherein the symbol of the other input/output cell has a plurality of pins including the pin, and, in generating the schematic data, the schematic generating unit selects, on the symbol of the one input/output cell, about whether the through pins are connected to the pins of the symbol of the other input/output cell, or are connected to the power pins of the symbol of the one input/output cell itself.

6. The method according to claim 2, wherein, in generating the layout data, when the through pins are connected to the power pins of the symbol of the one input/output cell itself in generating the schematic data, the layout generating unit displays a prompt for arranging vias in portions corresponding to the through pins in the object of the power rails.

7. The method according to claim 3, wherein, in generating the layout data, when the through pin is connected to the power pin of the symbol of the one input/output cell itself in generating the schematic data, the layout generating unit displays a prompt for arranging a via in a portion corresponding to the through pin in the object of the power rails.

8. The method according to claim 1, wherein the schematic generating unit is functionally realized in the computer by executing a schematic editor.

9. The method according to claim 1, wherein the layout generating unit is functionally realized in the computer by executing a layout editor.

10. The method according to claim 9, wherein the layout editor generates the layout data according to the schematic data.

11. The method according to claim 10, wherein the layout editor arranges the objects of the IO cell and the power rails on the layout diagram according to the schematic data, and generates the layout data.

12. The method according to claim 4, wherein the information indicating the power rails includes pin names of the pins which are displayed in the symbol.

13. The method according to claim 4, wherein the prompt for arranging the via is displayed by at least highlighting or blinking a portion corresponding to the through pin.

14. The method according to claim 1, wherein the input/output circuit includes an electro-static protection element.
